(19) United States
(12) Patent Application Publication
(10) Pub. No.: US 2009/0265097 A1
(43) Pub. Date: Oct. 22, 2009

(54) APPARATUS FOR VEHICLE NAVIGATION

(75) Inventors: Tetsuro Adachi, Okazaki-city (JP); Akira Tsukamoto, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/385,595

(22) Filed: Apr. 14, 2009

(30) Foreign Application Priority Data
Apr. 18, 2008 (JP) 2008-108854

(51) Int. Cl. G01C 21/36

(52) U.S. Cl. 701/204; 701/209

(57) ABSTRACT

A vehicle navigation apparatus having a travel time map display function includes: a display unit for displaying a map around the vehicle together with a route and an expected travel time of the route; and a calculation unit for calculating the expected travel time of the route that is extending from a start point to a destination, when the travel time map display function is shown as an option in a menu screen. Upon selection of the function, the expected travel time of the route is displayed under a circumstance that (a) multiple registered points are pre-registered to the navigation apparatus, (b) one of the multiple registered points serves as the start point of multiple routes, and (c) each of the rest of the multiple registered points respectively serves as the destination of the multiple routes.

### CROSS REFERENCE TO RELATED APPLICATION

The present application is based on and claims the benefit of priority of Japanese Patent Application No. 2008-108854, filed on Apr. 18, 2008, the disclosure of which is incorporated herein by reference.

### FIELD OF THE DISCLOSURE

The present disclosure generally relates to a vehicle navigation apparatus that displays a travel time of a vehicle to a user-desired travel destination in an easily recognizable form of representation.

### BACKGROUND INFORMATION

Conventionally, a navigation apparatus for use in, for example, a vehicle displays a current vehicle position and a destination position as well as a guidance route toward the destination of a travel according to information from a global positioning system and map information or the like, after having an input of a destination.

The navigation apparatus disclosed in Japanese patent document JP-A-2005-172702, for example, shows an expected travel time to the destination and, as traffic information, an indicator arrow along the roads that represents, by using a color scheme, a degree of congestion in some of the sections of the roads when the destination is input and the route toward the destination is searched on the map (refer to FIGS. 4 & 8, and a paragraph [0072]). Further, in the apparatus disclosed in Japanese patent document JP-A-2006-46913 (or an equivalent US publication 20060025924, FIG. 11 and a paragraph [0063] for example), arrival times to frequently visited places are displayed on the map when those places are pre-registered.

However, in the former case, the indicator arrow along the roads for showing the congestion cannot tell, for the user, the required travel time to the destination.

Further, the latter case of having the pre-registered points must have those points pre-registered to the apparatus in advance. That is, in other words, the apparatus cannot estimate the travel time to a first-time-visited place.

### SUMMARY OF THE DISCLOSURE

In view of the above and other problems, the present disclosure provides a navigation apparatus and a method that displays a travel time to a user-desired travel destination in an easily recognizable manner.

In an aspect of the present disclosure, the vehicle navigation system having a map display function for use in a vehicle, includes: a display unit for display of a map around the vehicle together with a route and an expected travel time of the route; and a calculation unit for calculating the expected travel time of a route that is extending from a start point to a destination, when (a) multiple registered points are pre-registered to the navigation system, (b) one of the multiple registered points serves as the start point of multiple routes, and (c) each of the rest of the multiple registered points respectively serves as the destination of the multiple routes.

The navigation apparatus thus provides a clue of a travel time from the current position to a desired destination for the user, by displaying the expected travel time between the two registered points respectively close to the current position and the destination as a reference travel time. That is, the navigation apparatus of the present disclosure shows the travel time to the destination represented in an easily recognizable manner for the user.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a vehicle navigation apparatus in an embodiment of the present disclosure;

FIGS. 2A to 2C are illustrations of representation scheme of expected travel times to respective destinations on a display unit of the navigation apparatus;

FIG. 3 is a flow chart of a process for calculating the expected travel time;

FIG. 4 is a block diagram of a vehicle navigation apparatus that communicates with a traffic information center in another embodiment of the present disclosure;

FIG. 5 is a flow chart of another process for calculating the expected travel time; and

FIG. 6 is another illustration of representation scheme of the expected travel time.

### DETAILED DESCRIPTION

The embodiments of the present invention are described in the following with reference to the drawing.

### 1. First Embodiment

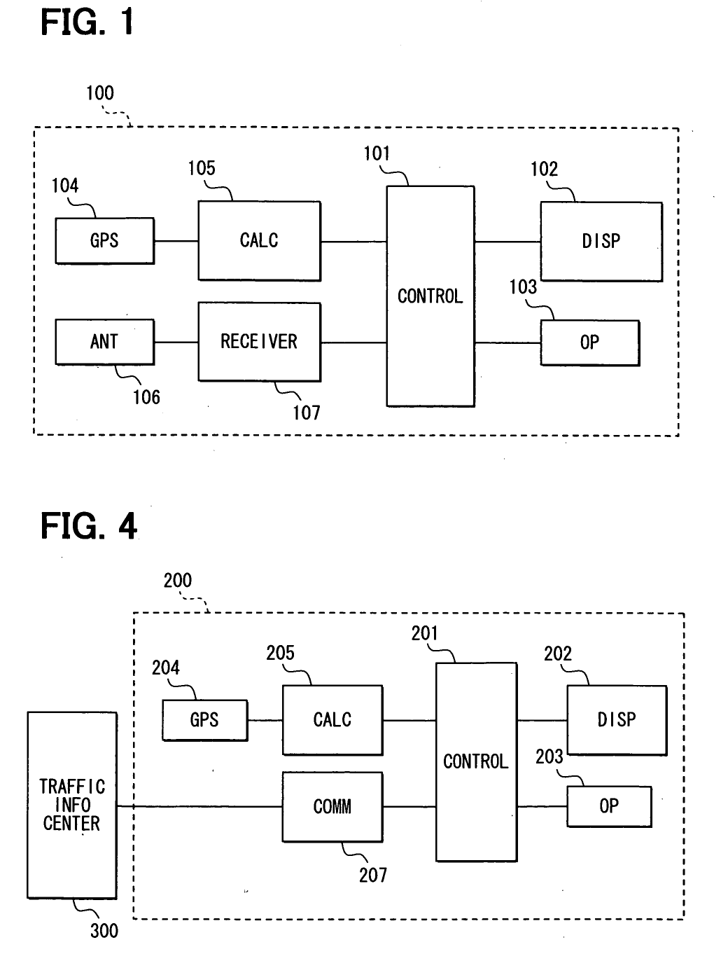

FIG. 1 is a functional block diagram of a configuration of a vehicle navigation apparatus 100.

### 1.1. Configuration of Navigation Apparatus

The navigation system implemented as a navigation apparatus 100 includes, as shown in FIG. 1, a GPS sensor 104 for measurement and detection of a current position, a current position calculation unit 105 for calculation of the current position by processing an output signal from the GPS sensor 104, a traffic information reception unit 107 for receiving traffic information through broadcasted radio wave or the like by an antenna 106, as well as a display unit 102 for displaying various information, an operation unit 103 for an input of user operation and a control unit 101 that provides navigation functions such as route guidance, map display and the like together with performing a total control of the navigation apparatus 100.

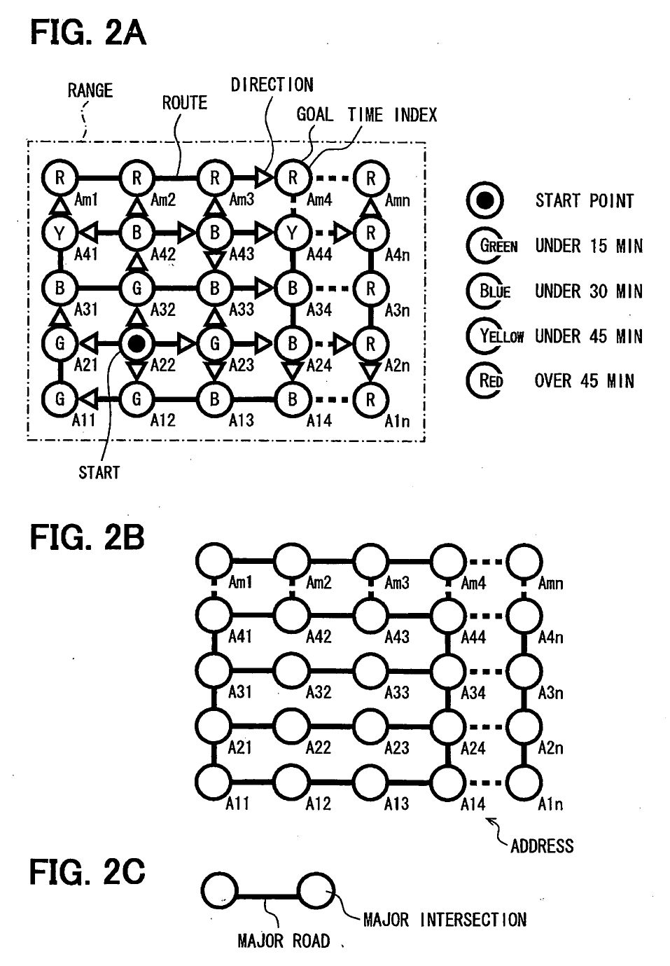

The control unit 101 receives the latest traffic information that is regularly updated through the antenna 106 and the traffic information reception unit 107, and accumulates the data in the control unit 101 for updating the latest traffic information data. Also, the control unit 101 statistically processes the accumulated data for the storage as the statistical data. Further, the control unit 101 is capable of retaining a road map of a specific area range (i.e., “RANGE” in FIG. 2A) being composed of major roads and registered points (i.e., major intersections) as a “skeleton” or as a “framework,” and calculates a route between two registered points and an expected travel time of the route when one of the registered points is set as a departure point (i.e., a start point) and each of the other points are set as a destination point (i.e., an end point). Further, the illustration in FIG. 2C shows a relation between the major road and the major intersections. Furthermore, in the specific area range, each of the major intersections has an address assigned thereto (e.g., A11, A12 to Amn: see FIG. 2B). In addition, the control unit 101 displays the calculation result of the route and the expected travel time by using the skeleton on the display unit 102 as shown in FIG. 2A. Furthermore, the control unit 101 is capable of storing multiple registration of specific area ranges registered thereto, for selectively displaying a suitable area range according to the current position.

More practically, when the “skeleton map” of the expected travel time is selected in a menu screen on the display unit 102 by an input from the operation unit 103, the control unit 101 uses one of the registered points close to the current position as the start point to calculate optimum routes to other registered points in the specific area range, based on the latest traffic information and estimation information upon having a request for the required travel time from the current position based on an input from the operation unit 103. Then, the control unit 101 generates travel time data which shows required time to each of the destinations (i.e., the registered points) by using the numbers, signs, or colors as well as information of an entrance direction that specifies a travel direction of the vehicle when the vehicle enters the intersection. After calculation of the routes and travel times, the control unit 101 outputs the calculation results to the display unit 102 along with the skeleton map of the roads. In this manner, the map as illustrated in FIG. 2A is shown on the display unit 102, and the required time to each of the registered points from the current position are represented on the road map. Therefore, the required travel time from the current position to the destination can be grasped by the user of the navigation apparatus 100.

### 1.2. Required Time Calculation Processing (1)

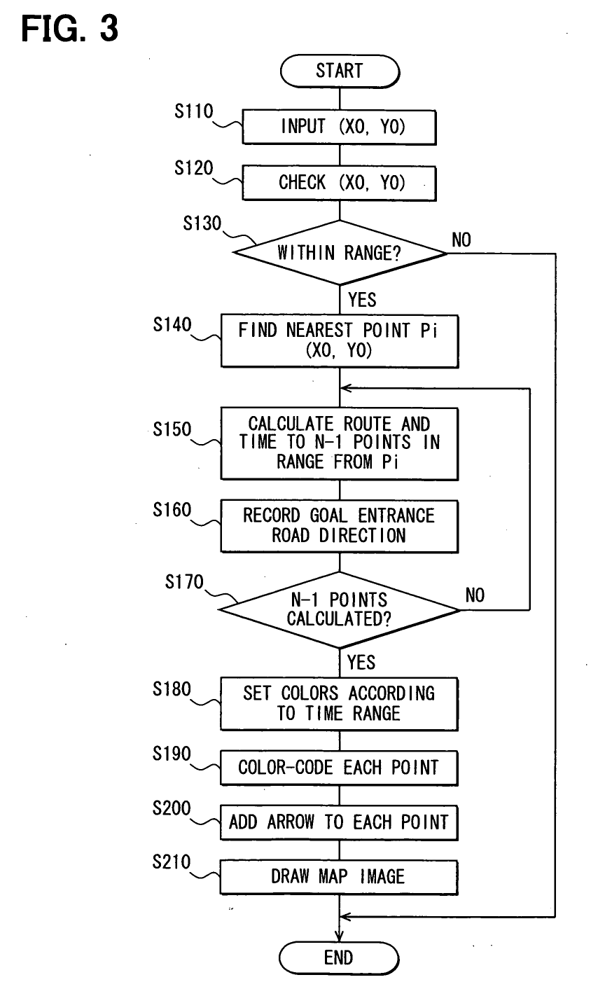

Next, the required time calculation processing (1) which is performed by the control unit 101 is described while referring to a flow chart in FIG. 3 as well as referring to FIGS. 2A to 2C.

First, in S110, an input of current position information (X0,Y0) is accepted. The current position information (X0,Y0) is the coordinates which show the current position of the vehicle based on calculation processing of an output signal from the GPS sensor 104 by using the current position calculation unit 105.

Then, in S120, whether or not the above-mentioned current position information (X0,Y0) indicates a position in the specific area range is examined. The specific area range, in this case, is an area which is currently selected as a scope of view. When the current position information (X0,Y0) doesn't indicate a position in the specific area range, the processing ends without any further step (S130: NO). On the other hand, when the current position information (X0,Y0) indicates a position in the specific area range, the processing shifts to S140 (S130: YES).

The processing in S140 identifies one of the registered points, that is, a point Pi (Xi,Yi) which is nearest to the current position (X0,Y0), out of all the registered points (P1-PN) of N pieces which exist in the specific area range as pre-registered points. Then, the processing in S150 sets the identified registered point Pi (Xi,Yi) as the start point, and the sets other points in the specific area range as end points, for calculating the optimum routes between the start point and end points as well as the required travel time of those routes, based on the latest traffic information and the estimation information. In this case, the route calculation is performed for each of the registered points in the specific area range except for the start point. Further, the calculation is performed based on the required travel time for each section in the route at the moment of calculation (i.e., a currently required travel time), or based on the predicted travel time for each section in the route at the moment of calculation (i.e., a prediction of required travel time).

Then, the processing in S160 calculates the direction along which the vehicle enters the registered point that serves as the end point of the route, and records the calculated entrance direction for each of the routes.

Then, the processing in S170 determines, for each of the multiple routes starting from the registered point Pi (Xi,Yi) to each of the other registered points, whether the route calculation has been finished. If the calculation has not been finished (S170: NO), the processing returns to S150 and repeats the route calculation. On the other hand, if the route calculation has been finished, the processing shifts to S180 (S170: YES).

The processing in S180 sets a specific color for respective value ranges of the required travel time for each of the calculated routes. In the present embodiment, a value range of the required travel time under 15 minutes is set to a color of green, a value range under 30 minutes is set to blue, a value range under 45 minutes is set to yellow, and a value range equal to or greater than 45 minutes is set to red (see FIG. 2A for reference).

Then, in S190, the processing displays, by using color-coded marking defined in S180, each of the multiple routes on the map.

Then, in S200, the processing adds an entrance direction mark (i.e., an arrow) on each of the registered points on the map that serves as the end point of each of the multiple routes.

Then, in S210, the processing draws the map in a finished form on the display unit 102. In the map, the registered points representing the intersections are highlighted together with the routes, and the start point is represented by using a different mark from the other registered points. In the present embodiment, the start point is represented by a double circle mark.

As for the additional comment, FIG. 2A shows only one example of required travel time representation, that is, the color-coded representation scheme of required travel time to the major intersections for the ease of intuitive recognition. Further, a mark “Δ” in the illustration indicates an entrance direction for entering the intersection, which minimizes the required travel time. In other words, by successively tracing the “Δ” marks, the vehicle is navigated along the optimum route (i.e., the shortest route) to the destination, and thus the required travel time is minimized.

Then, the present processing is finished.

### 1.3. The Advantageous Effects of the Present Embodiment

The navigation apparatus 100 of the present embodiment calculates the multiple routes that extend from one of the registered points to each of the other registered points, and calculates the required travel time for the travel of each of the calculated routes, in order to display the required travel time of each route in association with the route itself on the map.

Therefore, the user can easily recognize and estimate the travel time from the current position to the desired destination, by referring to the estimation of the required travel time of the route on the map, the route extending from the nearest registered point close to the current position to the registered point close to the desired destination. In other words, the travel time to the desired destination is displayed in an easily recognizable form of representation by using the technique of the present disclosure.

### 2. Second Embodiment

FIG. 4 is a functional block diagram of a configuration of vehicle navigation apparatus 200 and a traffic information distribution center 300.

### 2.1. Configuration of Navigation System

A vehicle navigation system is composed of the traffic information distribution center (hereinafter designated as a “center”) 300 which generates and distributes information product derived from the traffic information for the navigation apparatus 200 (i.e., vehicle unit 200) in combination with the vehicle unit 200.

The center 300 has a function for continuously receiving latest traffic information from a traffic information provider and a function for generating estimation information based on the traffic information and statistics, and provides useful data that can be used for calculation of an optimum route between registered points in a specific area together with the required travel time of the route, and can also be used for the display of the required travel time on a screen of the vehicle unit or the like.

The vehicle unit 200 communicates with the center 300 through a communication unit 207. The vehicle unit 200 transmits, through the communication unit 207 to the center 300, a display request for displaying the required travel time to the registered point in the specific area by acquiring the current vehicle position from a GPS sensor 204 and from a current position calculation unit 205 under control of a control unit 201, when the request is input by using a display unit 202 and an operation unit 203. On the other hand, when the center 300 receives the request from the vehicle unit 20, the center requests the vehicle unit 200 for information on the current vehicle position. Then, the vehicle unit 200 generates current position information to be provided for the center 300 with the control unit 201, and provides the information for the center 300 through the communication unit 207.

Then, the center 300 calculates multiple routes and required travel times, the optimum (i.e., the shortest) routes starting from a registered point nearest to the received current vehicle position and ending at the rest of the registered points. Further, the center 300 has a function to generate both of latest traffic information and estimation information by utilizing the latest traffic information. Therefore, the estimation accuracy can be improved by the generated information in the calculation of the shortest routes and the like.

### 2.2. Required Time Calculation Processing (2)

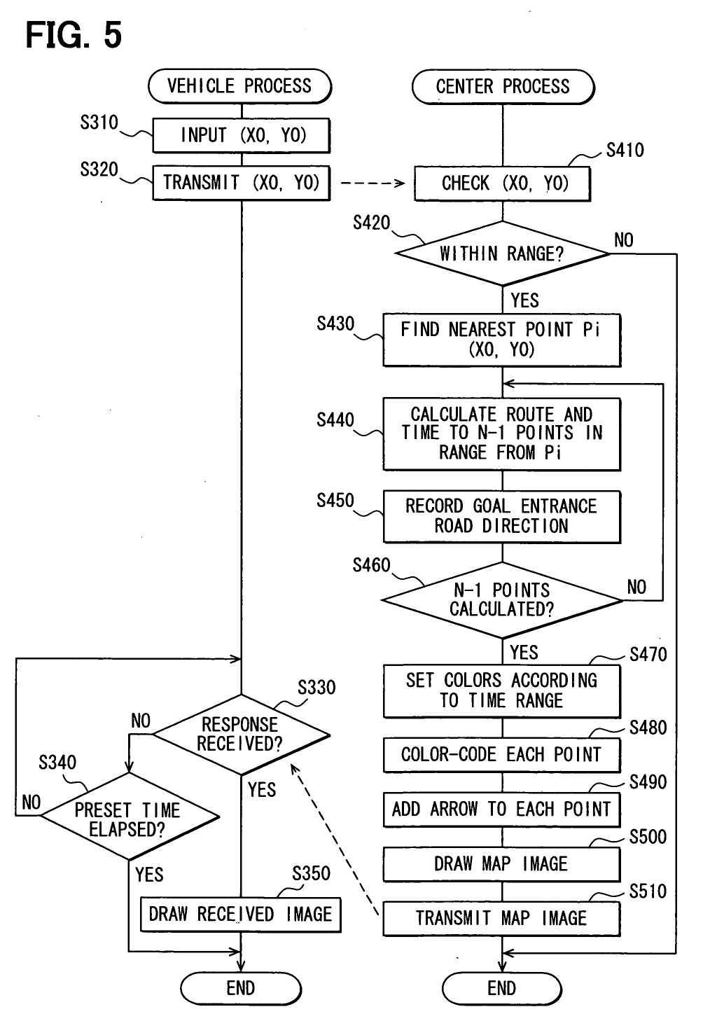

The required time calculation processing (2) performed by the navigation system is described with reference to a flow chart in FIG. 5 and to the illustration in FIG. 2A.

First, on the vehicle unit 200 side, an input of current position information (X0,Y0) is accepted (S310). The current position information (X0,Y0) is the coordinates which show the current position of the vehicle based on calculation processing of an output signal from the GPS sensor 204 by using the current position calculation unit 205. Then, the above-mentioned current position information (X0,Y0) is transmitted to the center 300 through the communication unit 207. Then, the vehicle unit 200 stands by until it receives a response from the center 300 (S330: NO). The waiting for the response lasts until a preset amount of time elapses. That is, if the response has not been received before the preset amount of time elapses (S340: YES), the processing concludes itself.

On the other hand, the center 300 examines whether or not the above-mentioned current position information (X0,Y0) transmitted from the vehicle unit 200 indicates a position in the specific area range (S410). The specific area range, in this case, is an area which is currently selected as a scope of view. When the current position information (X0,Y0) doesn't indicate a position in the specific area range, the processing ends without any further step (S420: NO). On the other hand, when the current position information (X0,Y0) indicates a point in the specific area range, the processing shifts to S430 (S420: YES).

The processing in S430 identifies one of the registered points, that is, a point Pi (Xi,Yi) which is nearest to the current position (X0,Y0), out of all the registered points (P1-PN) of N pieces which exist in the specific area range as pre-registered points. Then, the processing in S440 sets the identified registered point Pi (Xi,Yi) as the start point, and the sets other points in the specific area range as end points, for calculating the optimum routes between the start point and end points as well as the required travel time of those routes, based on the latest traffic information and the estimation information. In this case, the route calculation is performed for each of the registered points in the specific area range except for the start point. Further, the calculation is performed based on the required travel time for each section in the route at the moment of calculation (i.e., a currently required travel time), or based on the predicted travel time for each section in the route at the moment of calculation (i.e., a prediction of required travel time).

Then, the processing in S450 calculates the direction along which the vehicle enters the registered point that serves as the end point of the route, and records the calculated entrance direction for each of the routes.

Then, the processing in S460 determines, for each of the multiple routes starting from the registered point Pi (Xi,Yi) to each of the other registered points, whether the route calculation has been finished. If the calculation has not been finished (S460: NO), the processing returns to S440 and repeats the route calculation. On the other hand, if the route calculation has been finished (S460: YES), the processing shifts to S470.

The processing in S470 sets a specific color for respective value ranges of the required travel time for each of the calculated routes. In the present embodiment, a value range of the required travel time under 15 minutes is set to a color of green, a value range under 30 minutes is set to blue, a value range under 45 minutes is set to yellow, and a value range equal to or greater than 45 minutes is set to red (see FIG. 2A for reference).

Then, in S480, the processing displays, by using color-coded marking defined in S470, each of the multiple routes on the map.

Then, in S490, the processing adds an entrance direction mark (i.e., an arrow) on each of the registered points on the map that serves as the end point of each of the multiple routes.

In S500, the processing completes the map, and draws the map image.

In S510, the processing transmits the map image to the vehicle unit 200.

On the other hand, in the vehicle unit 200, if the response from the center 300 is received (S330: YES), the received map image is drawn on the display unit 202 (S350). In the map, the registered points representing the intersections are highlighted together with the routes, and the start point is represented by using a different mark from the other registered points. In the present embodiment, the start point is represented by a double circle mark. As for the additional comment, FIG. 2A shows only one example of required travel time representation, that is, the color-coded representation scheme of required travel time to the major intersections for the ease of intuitive recognition. Further, a triangle mark “Δ” in the illustration indicates an entrance direction for entering the intersection, which minimizes the required travel time. In other words, by successively tracing the “Δ” marks, the vehicle is navigated along the optimum route (i.e., the shortest route) to the destination, and thus the required travel time is minimized.

### 2.3. The Advantageous Effects of the Present Embodiment

The navigation system of the present embodiment calculates the multiple routes that extend from one of the registered points to each of the other registered points, and calculates the required travel time for the travel of each of the calculated routes, in order to display the required travel time of each route in association with the route itself on the map.

Therefore, the user can easily recognize and estimate the travel time from the current position to the desired destination, by referring to the estimation of the required travel time of the route on the map, the route extending from the nearest registered point close to the current position to the registered point close to the desired destination. In other words, the travel time to the desired destination is displayed in an easily recognizable form of representation by using the technique of the present disclosure.

### 3. Other Embodiment

Although the present disclosure has been fully described in connection with preferred embodiment thereof with reference to the accompanying drawings, it is to be noted that various changes and modifications will become apparent to those skilled in the art.

(1) In the above embodiments, the start point of the route is set to the nearest registered point Pi (X0,Y0) that is nearest to the current vehicle position from among all of the registered points (P1-PN) of N pieces in the specific area range. However, the user input may be used to set the start point of the route through the operation unit 103. In this manner, the required travel time of the route between the two user-desired points can be easily calculated and displayed, regardless of the current vehicle position.

(2) In the above embodiments, the calculated travel time for each of the multiple routes is color-coded according to the preset value ranges of the travel time. However, the color-coded representation scheme may be replaced with other schemes, such as text representation scheme, numbering representation scheme, mark/icon representation scheme, geometrical figure representation scheme or the like.

(3) Further, when the required travel time is displayed on the map as mentioned above, text information such as place names, a required time, an estimated arrival time, and information on route recommendation may also be displayed.

(4) Furthermore, based on the calculation of preferably-estimated travel time which is derived from a preferable, e.g., non-congesting, traffic condition of the route, the difference between the preferably-estimated travel time and the prediction of the required travel time may be shown on the map according to the value range of the difference. This method may also provide an intuitive and easily-recognizable form of representation for representing the traffic condition between the registered points.

(5) Furthermore, the required travel time may be shown as numbers in the circles of the registered points. Alternatively, based on a standard travel time of each section that assumes a smoothly-flowing traffic condition, the traffic condition may be color-coded for the smoothness categories of, for example, “Smooth,” “Slower,” “Very-Slow,” or the like.

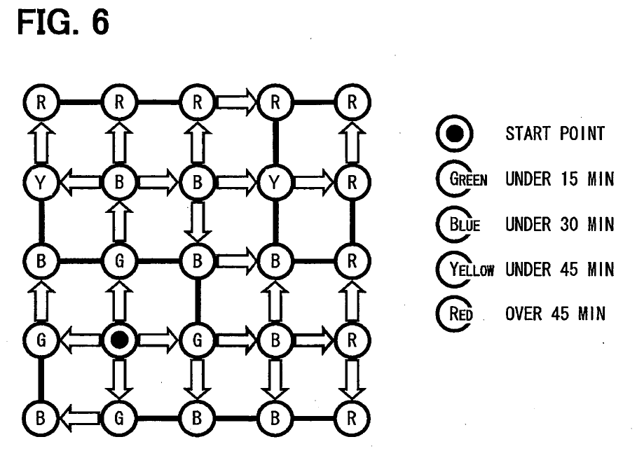

(6) Furthermore, the triangle marks (the arrows) for showing the entrance direction for entering the destination registered point may be replaced with hollow arrows as shown in FIG. 6, for the purpose of more intuitive and recognizable routing representation on the map.

Such changes, modifications, and summarized scheme are to be understood as being within the scope of the present disclosure as defined by appended claims.

What is claimed is:

1. A vehicle navigation apparatus having a map display function for use in a vehicle, the apparatus comprising:
a display unit for displaying a map around the vehicle together with a route and an expected travel time of the route; and
a calculation unit for calculating the expected travel time of the route that is extending from a start point to a destination, when (a) multiple registered points are pre-registered to the navigation apparatus, (b) one of the multiple registered points serves as the start point of multiple routes, and (c) each of the rest of the multiple registered points respectively serves as the destination of the multiple routes.

2. The vehicle navigation apparatus of claim 1, wherein
the map around the vehicle includes at least one preset range,
each of the at least one preset range has the multiple registered points, and
the start point and the destination are chosen from the multiple registered points in the preset range that includes a current position of the vehicle.

3. The vehicle navigation apparatus of claim 2, wherein
at least major highways and major intersections are located on the map.

4. The vehicle navigation apparatus of claim 3, wherein
the major intersections are pre-registered as the registered points.

5. The vehicle navigation apparatus of claim 1, wherein
a nearest point relative to the current position of the vehicle from among the multiple registered points is chosen as the start point.

6. The vehicle navigation apparatus of claim 1, wherein
an input to the navigation apparatus is accepted for choosing one of the multiple registered points as the start point, and
the start point is set according to the accepted input.

7. The vehicle navigation apparatus of claim 1, wherein
the calculation unit calculates the route from the start point to the destination based on traffic information, and
the calculation unit calculates the expected travel time of the calculated route that is required for a travel of the calculated route.

8. The vehicle navigation apparatus of claim 7, wherein
the traffic information includes a currently-required travel time of each section of the route,
the calculation unit uses the currently-required travel time of each section for calculating the expected travel time required for the travel of the route.

9. The vehicle navigation apparatus of claim 7, wherein
the traffic information includes a prospective travel time of each section of the route,
the calculation unit uses the prospective travel time of each section for calculating the expected travel time required for the travel of the route.

10. The vehicle navigation apparatus of claim 1, wherein
the calculation unit calculates an arrival time to the destination together with the expected travel time, and
the arrival time together with the expected travel time are displayed on the map around the vehicle.

11. The vehicle navigation apparatus of claim 1, wherein
representation of the expected travel time is selected according to a value range of the expected travel time.

12. The vehicle navigation apparatus of claim 1, wherein
the calculation unit calculates a preferable travel time on an assumption that the route has a preferable traffic condition,
representation of the expected travel time is selected according to a value range of a surplus difference of the expected travel time from the preferable travel time.

13. The vehicle navigation apparatus of claim 11, wherein
the representation is color-coded according to each of respective value ranges.

14. The vehicle navigation apparatus of claim 12, wherein
the representation is color-coded according to each of respective value ranges.

15. The vehicle navigation apparatus of claim 11, wherein
the representation takes a different sign form according to respective value ranges.

16. The vehicle navigation apparatus of claim 12, wherein
the representation takes a different sign form according to respective value ranges.

17. The vehicle navigation apparatus of claim 1, wherein
the multiple registered points and the multiple routes are highlighted on the map around the vehicle.

18. The vehicle navigation apparatus of claim 17, wherein
the start point is represented differently from other registered points on the map around the vehicle.

19. The vehicle navigation apparatus of claim 1, wherein
wherein a travel direction for entering the destination is displayed on the map around the vehicle.

20. A method for navigating a vehicle by using a map display function, the method comprising:
displaying a map around the vehicle together with a route and an expected travel time of the route; and
calculating the expected travel time of the route that is extending from a start point to a destination, when (a) multiple registered points are pre-registered to a navigation apparatus, (b) one of the multiple registered points serves as the start point of multiple routes, and (c) each of the rest of the multiple registered points respectively serves as the destination of the multiple routes.
